(19) United States
(12) Patent Application Publication
(10) Pub. No.: US 2009/0042449 A1
(43) Pub. Date: Feb. 12, 2009

(54) Connector and connector housing thereof

(75) Inventors: Yu-Yuan Tai, Taoyuan Hsien (TW); Yun Zuo, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 12/068,839

(22) Filed: Feb. 12, 2008

(30) Foreign Application Priority Data
Aug. 10, 2007 (TW) 96129619

(51) Int. Cl. H01R 24/00

(52) U.S. Cl. 439/660

(57) ABSTRACT

A connector electrically connected to a peripheral component interconnect express card includes a first body and a second body. The first body includes a plurality of connection holes provided to be correspondingly plugged by a plurality of plugs having electrical contacts. The second body is connected to the first body and volumetrically less than the first body. When the first and second bodies are connected, the connected first and second bodies has a top-view projecting profile corresponding to the shape of the peripheral component interconnect express card.

### BACKGROUND OF THE INVENTION

1. Field of the Invention

The invention relates to a connector, and, more particularly, to a connector capable of assembling with a peripheral component interconnect express (PCI-E) card with a high-speed integrated circuit.

2. Description of the Related Art

As shown in FIGS. 1 and 2, a peripheral component interconnect express (PCI-E) card 12 is an interface capable of being a substitute for AGP (accelerated graphics port) and providing I/O interface with a larger bandwidth. As shown in FIG. 2, due to the PCI-E card 12 having a particular profile which is different from that of a housing 11 of a RJ-45 connector 1, an interference area “A” is formed when the PCI-E card 12 is assembled with a RJ-45 connector 1 of the system. Therefore, installation of the PCI-E card 12 in the system is space-limited, and the available space for assembling all components is limited thereto.

Thus, there is a need to provide a connector capable of providing space matching with PCI-E card and a simplified structure that engages with the PCI-E card 12 without electromagnetic interference.

### BRIEF SUMMARY OF THE INVENTION

In view of the foregoing, an object of the invention is to meet the requirement of miniaturized assembly of a connector capable of providing space matching with PCI-E card and a simplified structure that engages with the PCI-E card 12 without electromagnetic interference.

To attain the above, a connector is provided. The connector of the invention is electrically connected to a peripheral component interconnect express card. The connector includes a first body and a second body. The first body includes a plurality of connection holes to be correspondingly plugged by a plurality of plugs having electrical contacts. The second body is assembled to the first body, and the top-view projecting width of the second body is smaller than that of the first body. When the first and second bodies are assembled, the assembled first and second bodies has a top-view projecting profile corresponding to the shape of the peripheral component interconnect express card.

As mentioned above, the connector of the embodiment provide a modified body, thereby reducing space for component assembly and the PCI-E card located in the system. Thus, the connector of the embodiment meets the requirements of miniaturized electronic products.

### BRIEF DESCRIPTION OF THE DRAWINGS

The invention can be more fully understood by reading the subsequent detailed description and examples with references made to the accompanying drawings, wherein:

FIG. 1 is a perspective view of a conventional connector;

FIG. 2 is a top view of a peripheral component interconnect express (PCI-E) card overlapped with the conventional connector of FIG. 1;

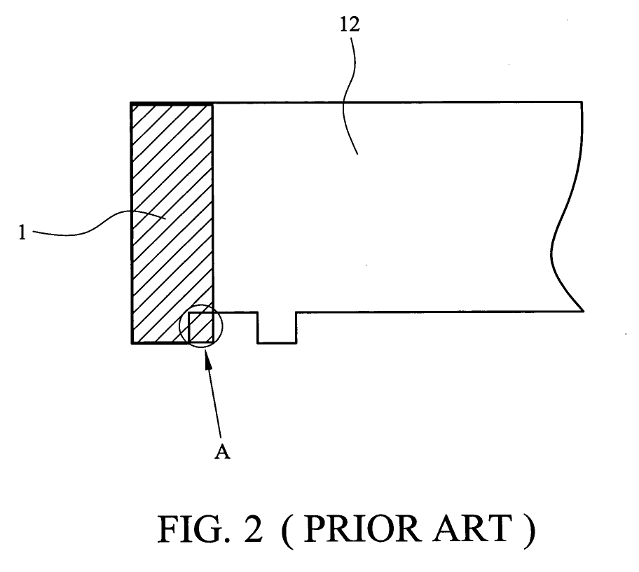

FIG. 3 is a perspective view of a connector of an embodiment of the invention;

FIG. 4 is a top view of a peripheral component interconnect express (PCI-E) card overlapped with the connector of FIG. 3;

FIG. 5 is another perspective view of the connector of the embodiment of the invention; and

FIG. 6 is a perspective view of the connector of the embodiment of the invention with the removal of a second housing.

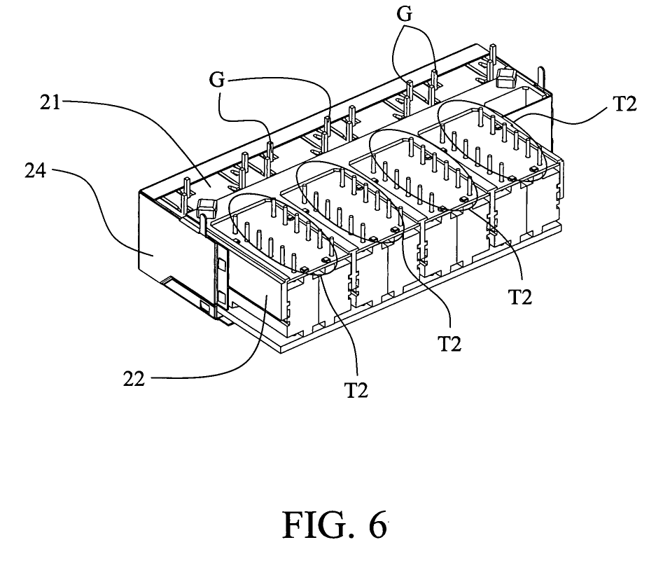

### DETAILED DESCRIPTION OF THE INVENTION

The following description is of the best contemplated mode of carrying out the invention. This description is made for the purpose of illustrating the general principles of the invention and should not be taken in a limiting sense. The scope of the invention is best determined by reference to the appended claims.

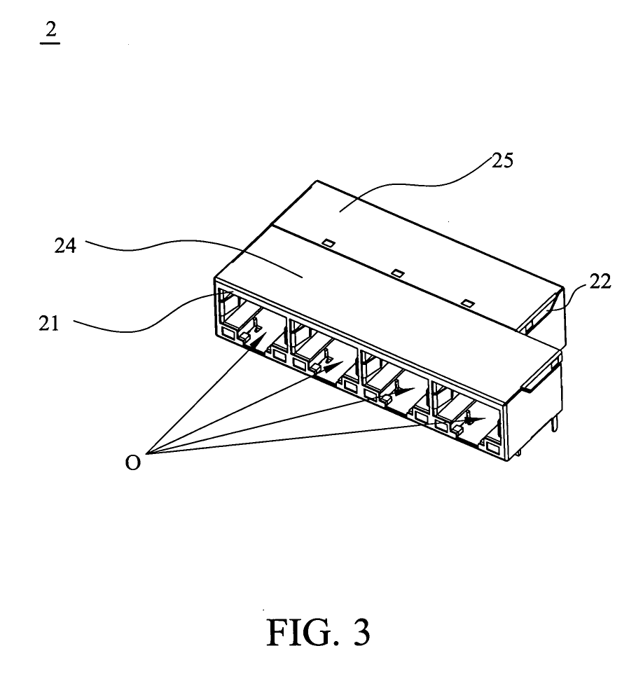

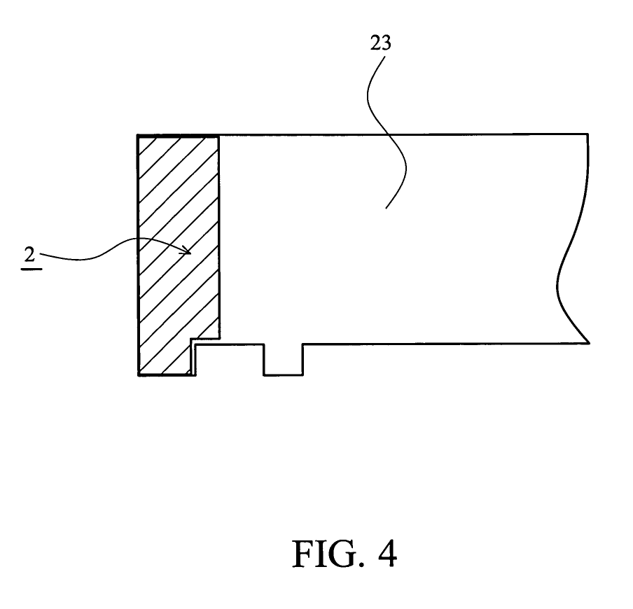

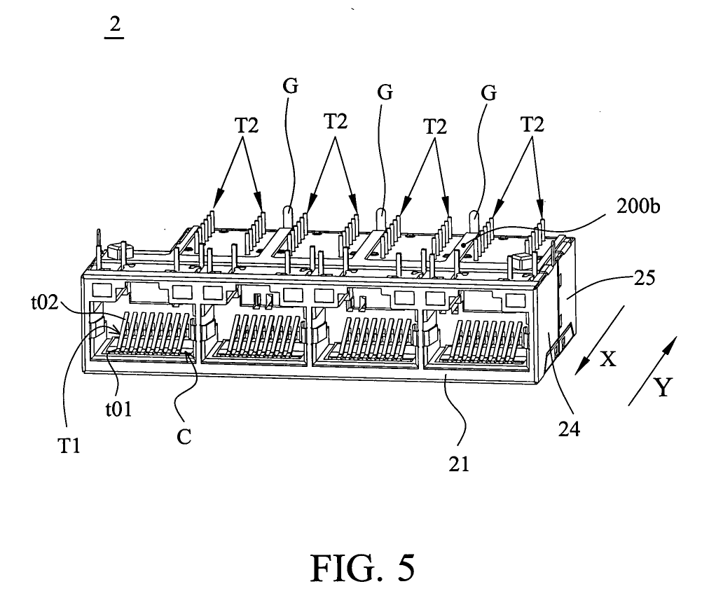

As shown in FIGS. 3, 4 and 5, a connector 2 of an embodiment is electrically connected to a peripheral component interconnect express (PCI-E) card 23 (shown in FIG. 4). The PCI-E card 23 comprises a high-speed integrated circuit.

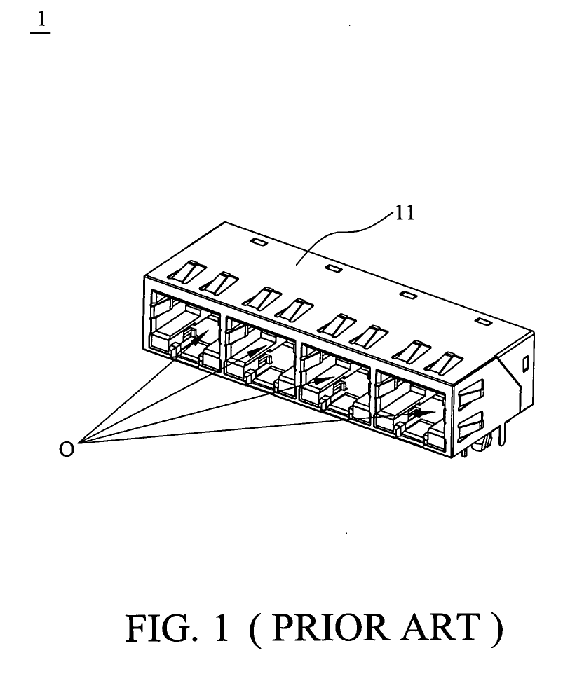

The connector 2 comprises a first body 21 having a plurality of connection, holes “O”, a second body 22 assembled to the first body 21, a first housing 24 covering the first body 21, a second housing 25 covering the second body 22, a circuit board “C” disposed at periphery of the connection holes “O” of the first body 21, a plurality of transmission terminals T1 disposed in the first body 21. The connection holes “O” of the first body 21 are provided to be correspondingly plugged by a plurality of plug's (not shown in figures) having electrical contacts for being electrically connected to the transmission terminals T1 (not shown in figures). Observed from a top-view projecting profile, the top view projecting width of the second body 22 is smaller than that of the first body 21, and the top-view projecting profile of the connector formed by the connected first and second bodies 21 and 22 is integrally formed with a stepped shape which substantially corresponds to the shape of the PCI-E card 23. Alternatively, the invention can be applied to a connector that a size of the first body is smaller than that of the first body. The transmission terminals T1 disposed in the connection holes “O” of the first body 21 are located at a peripheral of the connection holes “O”. Each transmission terminal T1 has a first end t01 and a second end t02. The first end t01 of the transmission terminal T1 coupled to the circuit board “C” extends along X direction. The second end t02 of the transmission terminal T1 connected to the first end t01 obliquely extends along a particular direction (Y direction) toward the connection hole “O” inside. Additionally, the shape of each connection hole “O” corresponds to that of each plug (not shown). In the embodiment, the connector 2 is, including but not limited to, RJ-11, RJ-12 or RJ-45 connector, and the plug is, including but not limited to, RJ-11, RJ-12 or RJ-45 plug. When the plug, such as RJ-11, RJ-12 or RJ-45 plug is plugged into the connection hole “O” of the first body 21, the plug is correspondingly contacted with the transmission terminals T1 to form an electric connection therebetween. The second body 22 comprises a plurality of extended signal terminals T2, such as a plurality of pins, utilized to transmit signals to the PCI-E card 23. In the embodiment, the amount of the connection holes “O” of the connector 2 is four, and the connection holes “O” have four sets of signal terminals T2. Due to the second body 22 being volumetrically less than the first body 21, the configuration of the four sets of signal terminals T2 is determined by the available space for the second body 22. Note that the relatively symmetrical configuration of the connection holes “O” and the signal terminals T2 of the embodiment is different from the conventional connector 1 of FIG. 1. The first and second housings 24 and 25 comprise a plurality of extended ground legs “G” located on the bottom surface 200b of the connector 2. In the embodiment, the ground legs “G” are extended from the bottom of the second housing 25 for grounding.

The first and second housings 24 and 25 contain an electromagnetic shielding material, thus, interference of electromagnetic interference (EMI) is prevented. The first housing 24 or the second housing 25 can be made of the electromagnetic shielding material, or the electromagnetic shielding material can be coated on the surfaces of the first and second housings 24, 25. The electromagnetic shielding material is a metal or metal alloy material. The connector 2 can be RJ-11, RJ-12 or RJ-45 connector.

Based on the described features, the connector of the embodiment provides a modified body, thereby reducing space for component assembly and the PCI-E card located in the system. Thus, the connector of the embodiment meets the requirements of miniaturized electronic products.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A connector electrically connected to a peripheral component interconnect express card, comprising:
a first body; and
a second body assembled with the first body;
wherein the assembled first and second bodies have a top-view projecting profile corresponding to the shape of the peripheral component interconnect express card.

2. The connector as claimed in claim 1, wherein the top-view projecting profile of the connected first and second bodies is a stepped shape.

3. The connector as claimed in claim 1, wherein a size of the second body is smaller than that of the first body.

4. The connector as claimed in claim 4, wherein the first body comprises a plurality, of connection holes provided to be correspondingly plugged by a plurality of plugs having electrical contacts.

5. The connector as claimed in claim 1, wherein the first body further comprises a plurality of transmission terminals disposed in the connection holes of the first body.

6. The connector as claimed in claim 5, wherein each of the plugs comprises a plurality of electrical contacts for being electrically connected to the transmission terminals of each of the connection holes.

7. The connector as claimed in claim 4, further comprising a circuit board disposed in each of the connection holes of the first body.

8. The connector as claimed in claim 7, wherein each transmission terminal comprises a first end coupled to the circuit board and a second end oblique extending toward the connection hole inside.

9. The connector as claimed in claim 1, wherein the second body comprises a plurality of extended signal terminals for transmitting signals to the peripheral component interconnect express card.

10. The connector as claimed in claim 1, wherein the extended signal terminals are a plurality of pins.

11. The connector as claimed in claim 1, further comprising a first housing covering the first body and a second housing covering the second body.

12. The connector as claimed in claim 11, wherein the first and second housings are made of an electromagnetic shielding material.

13. The connector as claimed in claim 12, wherein the electromagnetic shielding material comprises a metal or metal alloy material.

14. The connector as claimed in claim 11, wherein the second housing comprises a plurality of extended ground legs extending from a bottom surface of the connector.

15. The connector as claimed in claim 1, wherein the connector comprises RJ-11, RJ-12 or RJ-45 connector and the plug comprises RJ-11, RJ-12 or RJ-45 plug.

16. The connector as claimed in claim 1, wherein the peripheral component interconnect express card comprises a high-speed integrated circuit.

17. A connector comprising:
a first body; and
a second body assembled with the first body, wherein a size of the first body is smaller than that of the first body.

18. The connector as claimed in claim 17, wherein the first and second bodies respectively have a plurality of connection holes to be plugged by external plugs.

19. The connector as claimed in claim 17, further comprising a first housing for covering the first body, and a second housing for covering the second body, wherein the first and second housings are made of an electromagnetic shielding material.
